(19) United States
(12) Patent Application Publication
(10) Pub. No.: US 2013/0285917 A1
(43) Pub. Date: Oct. 31, 2013

(54) WIRELESS INPUT MODULE AND ELECTRONIC DEVICE USING SAME

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: GUANG-FENG OU, Shenzhen (CN); YONG-ZHAO HUANG, Shenzhen (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 13/775,979

(22) Filed: Feb. 25, 2013

(30) Foreign Application Priority Data
Apr. 25, 2012 (CN) 201210123400.2

(51) Int. Cl. G06F 3/023

(52) U.S. Cl. CPC G06F 3/0231
USPC 345/169

(57) ABSTRACT

A wireless input module includes a wireless keyboard and a mouse. The wireless keyboard includes a processor, and a wireless module, the wireless module is electronically connected to the processor. The mouse is electronically connected to the processor. The processor is operable to receive input signals from the wireless keyboard and the mouse and allow the wireless module to transmit the input signals to an external host.

### BACKGROUND

1. Technical Field

The disclosure generally relates to wireless input modules of electronic devices.

2. Description of the Related Art

Wireless keyboards, and wireless mice are the most common wireless input devices. Generally, the wireless keyboard, and the wireless mouse are independent devices having respective functions, and the each of the wireless keyboard and the wireless mouse includes a processor and a power supply. The processors and the power supplies occupy a large internal space of the wireless input devices, and also increase the size of the wireless input devices.

Therefore, there is room for improvement within the art.

### BRIEF DESCRIPTION OF THE DRAWINGS

Many aspects of an exemplary wireless input module can be better understood with reference to the following drawings. The components in the drawings are not necessarily drawn to scale, the emphasis instead being placed upon clearly illustrating the principles of the exemplary wireless input module. Moreover, in the drawings, like reference numerals designate corresponding parts throughout the several views. Wherever possible, the same reference numbers are used throughout the drawings to refer to the same or like elements of an embodiment.

FIG. 1 is a schematic view of an electronic device including a wireless input module, according to an exemplary embodiment.

FIG. 2 is a schematic view of the wireless input module shown in FIG. 1.

FIG. 3 is similar to FIG. 2, but showing the wireless input module in a used state.

FIG. 4 is a circuit block diagram of the wireless input module shown in FIG. 1.

### DETAILED DESCRIPTION

Reference is now made to the drawings to describe various embodiments of the present disclosure in detail.

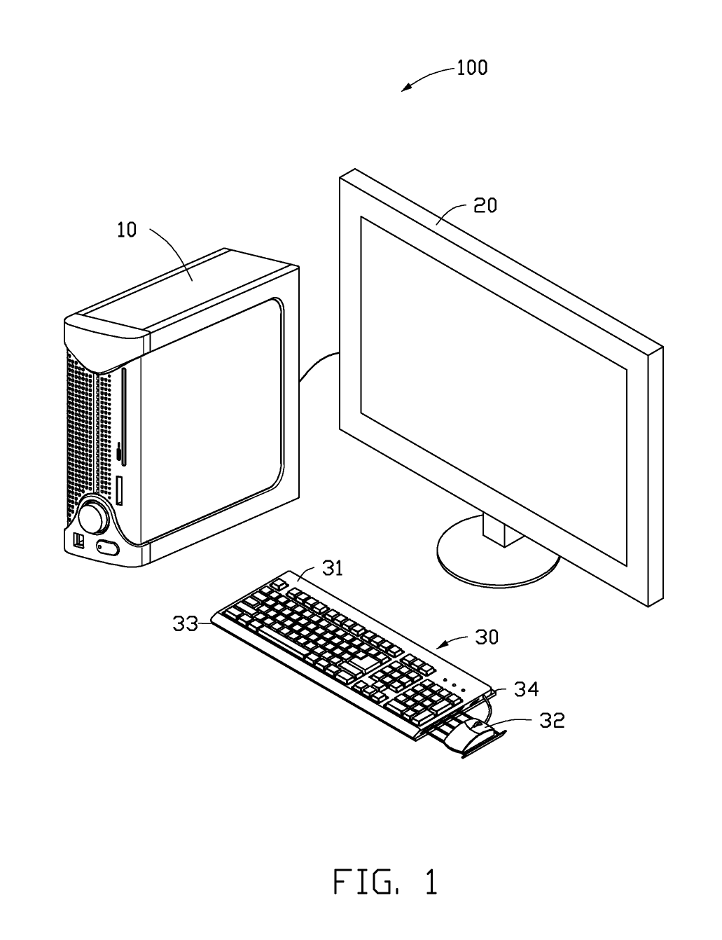

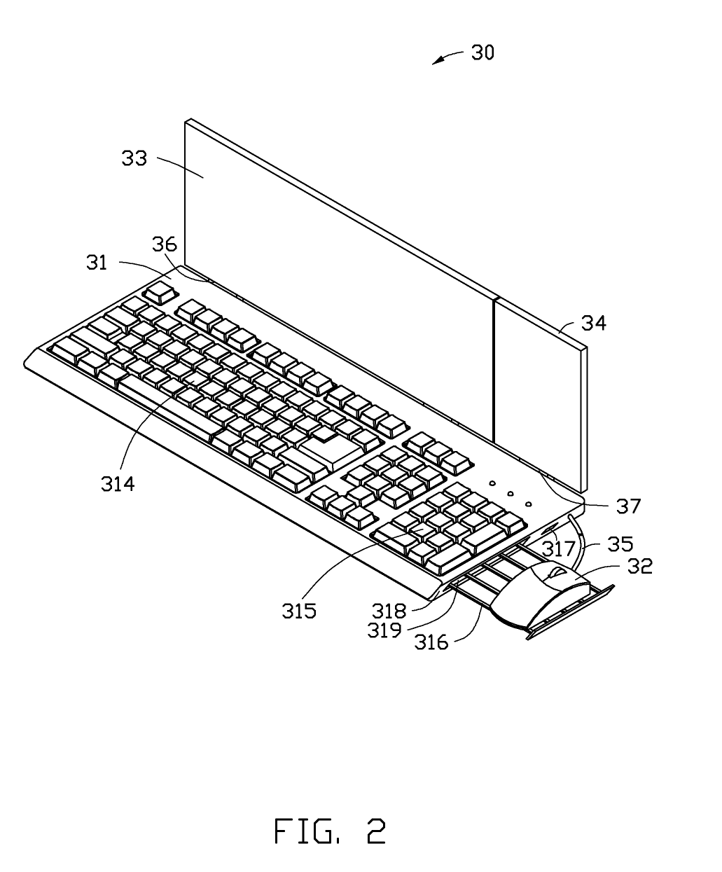

FIGS. 1 and 2 show an electronic device 100 according to an exemplary embodiment. The electronic device 100 includes a host 10, a monitor 20 electronically connected to the host 10, and a wireless input module 30 for inputting data to the host 10.

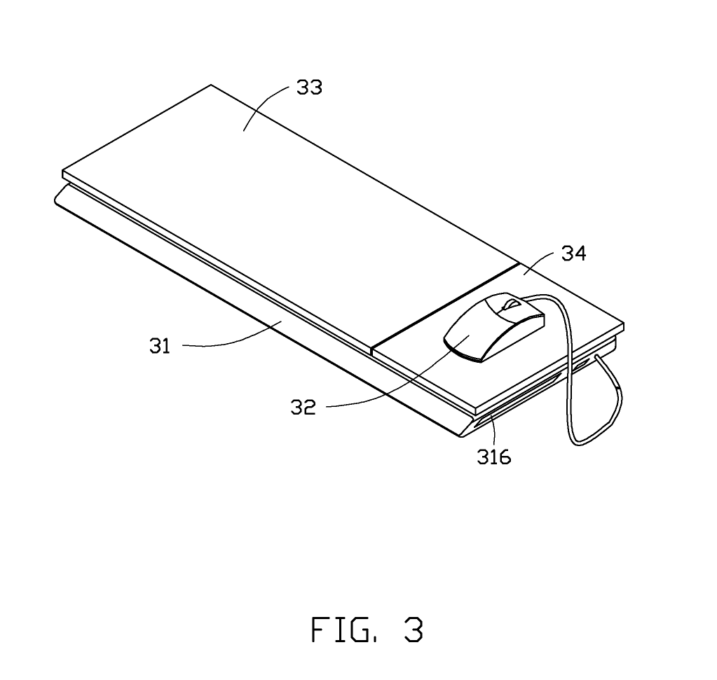

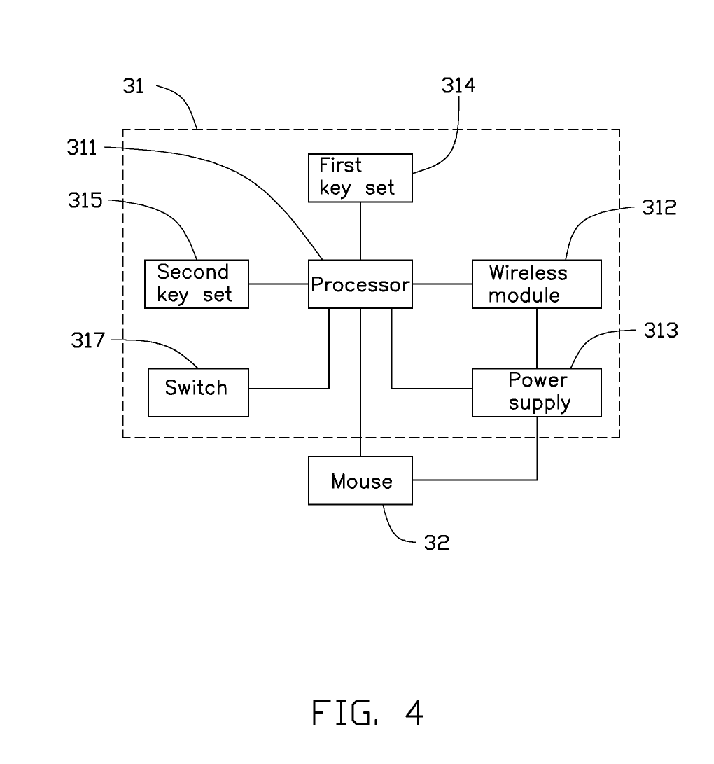

FIGS. 3 and 4 show that the wireless input module 30 includes a wireless keyboard 31, a mouse 32, a first plate 33, and a second plate 34. The mouse 32 is electronically connected to the wireless keyboard 31 through a wire 35. The first plate 33 is rotatably attached to the wireless keyboard 31 through a first hinge 36, and the second plate 34 is rotatably attached to the wireless keyboard 31 through a second hinge 37. In this embodiment, the first plate 33 and the second plate 34 are made of metal.

A first key set 314 and a second key set 315 are defined on the wireless keyboard 31. In this embodiment, the first key set 314 consists of alphabetical keys, and the second key set 315 consists of numeric keys. The first plate 33 may rotate to cover the first key set 314, and the second plate 34 may rotate to cover the second key set 315. A sidewall 318 of the wireless keyboard 31 defines a groove 319. A tray 316 is slidably received in the groove 319. A switch 317 adjacent to the groove 319 is located on the sidewall 318.

The wireless keyboard 31 includes a processor 311, a wireless module 312, a power supply 313, and the switch 317 electronically connected to the processor 311. The processor 311 is operable to receive input signals from the wireless keyboard 31 and the mouse 32 and allow the wireless module 312 to transmit the input signals to the host 10. According to the input signals, the host 10 controls the monitor 20 to display images corresponding to actions of the wireless keyboard 31 and the mouse 32. The power supply 313 provides power to the processor 311, the wireless module 312 and the mouse 32.

FIGS. 2 and 3 show that the wireless input module 30 functions as follows:

In this embodiment, the wireless input module 30 has three operating modes including a keyboard mode, a mouse mode, and an input mode. The switch 317 is configured for switching the operating modes and sends switch signals to the processor 311. According to the switch signals, the processor 311 enables or disables the wireless keyboard 31 and the mouse 32.

In keyboard mode, the mouse 32 is disabled and the wireless keyboard 31 is enabled under the control of the processor 311. The first plate 33 rotates relative to the wireless keyboard 31 to expose the first key set 314, and the second plate 34 rotates relative to the wireless keyboard 31 to expose the second key set 315. Users may input characters through the wireless keyboard 31 to the host 10 and the monitor 20 displays the characters under the control of the host 10.

In mouse mode, the wireless keyboard 31 is disabled and the mouse 32 is enabled under the control of the processor 311. The first plate 33 rotates relative to the wireless keyboard 31 to cover the first key set 314, and the second plate 34 rotates relative to the wireless keyboard 31 to cover the second key set 315. The mouse 32 may slide on the first plate 33 or the second plate 34, and a cursor displayed by the monitor 20 is moved corresponding to actions of the mouse 32.

In input mode, the second key set 315 is disabled under the control of the processor 311 and the second plate 34 rotates relative to the wireless keyboard 31 to cover the second key set 315. The first key set 314 and the mouse 32 are enabled, and the mouse 32 may slide on the second plate 34. Users may input characters through the first key set 314 and move the cursor displayed by the monitor 20 through the mouse 32.

The wireless keyboard 31 and the mouse 32 have common power supply 313, common processor 311, and common wireless module 312, thus, an internal space of the wireless input module 30 is saved. The wireless input module 30 has a variety of operating modes which can be switched through the switch 317 and is convenient to use. The first plate 33 and the second plate 34 made of metal may reduce electromagnetic emissions when covering the wireless keyboard 31.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A wireless input module, comprising:
a wireless keyboard comprising a processor and a wireless module, the wireless module electronically connected to the processor; and
a mouse electronically connected to the processor;
wherein the processor is operable to receive input signals from the wireless keyboard and the mouse and allow the wireless module to transmit the input signals to an external host.

2. The wireless input module as claimed in claim 1, further comprising a first plate and a second plate, wherein the first plate and the second plate are rotatably attached to the wireless keyboard.

3. The wireless input module as claimed in claim 2, wherein the first plate and the second plate are made of metal.

4. The wireless input module as claimed in claim 2, wherein a first key set and a second key set are defined on the wireless keyboard, the first plate rotates to cover the first key set, and the second plate rotates to cover the second key set.

5. The wireless input module as claimed in claim 4, wherein a sidewall of the wireless keyboard defines a groove, and a tray is slidably received in the groove.

6. The wireless input module as claimed in claim 4, wherein the wireless keyboard further comprises a switch electronically connected to the processor and a power supply; the processor, the wireless module and the mouse are electronically connected to the power supply.

7. The wireless input module as claimed in claim 6, wherein the wireless input module has three operating modes including a keyboard mode, a mouse mode, and an input mode, the switch is configured for switching the operating modes and sends switch signals to the processor; according to the switch signals, the processor enables at least one of the wireless keyboard and the mouse.

8. The wireless input module as claimed in claim 7, wherein in mouse mode, the wireless keyboard is disabled and the mouse is enabled under the control of the processor; the first plate rotates relative to the wireless keyboard to cover the first key set, and the second plate rotates relative to the wireless keyboard to cover the second key set.

9. The wireless input module as claimed in claim 7, wherein in keyboard mode, the mouse is disabled and the wireless keyboard is enabled under the control of the processor; the first plate rotates relative to the wireless keyboard to expose the first key set, and the second plate rotates relative to the wireless keyboard to expose the second key set.

10. The wireless input module as claimed in claim 7, wherein in input mode, the second key set is disabled under the control of the processor and the second plate rotates relative to the wireless keyboard to cover the second key set; the first key set and the mouse are enabled.

11. An electronic device, comprising:
a host;
a monitor electronically connected to the host; and
a wireless input module for inputting data to the host, the wireless input module comprising:
a wireless keyboard comprising a processor, and a wireless module, the wireless module electronically connected to the processor;
a mouse electronically connected to the processor;
wherein the processor is operable to receive input signals from the wireless keyboard and the mouse and allow the wireless module to transmit the input signals to the host, according to the input signals, the host allows the monitor to display images corresponding to actions of the wireless keyboard and the mouse.

12. The electronic device as claimed in claim 11, further comprising a first plate and a second plate, wherein the first plate and the second plate are rotatably attached to the wireless keyboard.

13. The electronic device as claimed in claim 12, wherein the first plate and the second plate are made of metal.

14. The electronic device as claimed in claim 12, wherein a first key set and a second key set are defined on the wireless keyboard, the first plate rotates to cover the first key set, and the second plate rotates to cover the second key set.

15. The electronic device as claimed in claim 12, wherein a sidewall of the wireless keyboard defines a groove, and a tray is slidably received in the groove.

16. The electronic device as claimed in claim 12, wherein the wireless keyboard further comprises a switch electronically connected to the processor and a power supply; the processor, the wireless module and the mouse are electronically connected to the power supply.

17. The electronic device as claimed in claim 16, wherein the wireless input module has three operating modes including a keyboard mode, a mouse mode, and an input mode, the switch is configured for switching the operating modes and sends switch signals to the processor; according to the switch signals, the processor enables at least one of the wireless keyboard and the mouse.

18. The electronic device as claimed in claim 17, wherein in mouse mode, the wireless keyboard is disabled and the mouse is enabled under the control of the processor; the first plate rotates relative to the wireless keyboard to cover the first key set, and the second plate rotates relative to the wireless keyboard to cover the second key set.

19. The electronic device as claimed in claim 17, wherein in keyboard mode, the mouse is disabled and the wireless keyboard is enabled under the control of the processor; the first plate rotates relative to the wireless keyboard to expose the first key set, and the second plate rotates relative to the wireless keyboard to expose the second key set.

20. The electronic device as claimed in claim 17, wherein in input mode, the second key set is disabled under the control of the processor and the second plate rotates relative to the wireless keyboard to cover the second key set; the first key set and the mouse are enabled.
